(19) United States
(12) Patent Application Publication
(10) Pub. No.: US 2026/0122341 A1
(43) Pub. Date: Apr. 30, 2026

(54) IMAGE PICKUP APPARATUS CAPABLE OF PERFORMING PRE-PHOTOGRAPHING, CONTROL METHOD FOR IMAGE PICKUP APPARATUS, AND STORAGE MEDIUM

(71) Applicant: CANON KABUSHIKI KAISHA, Tokyo (JP)

(72) Inventor: JUN KAMEDA, Tokyo (JP)

(21) Appl. No.: 19/339,627

(22) Filed: Sep. 25, 2025

(30) Foreign Application Priority Data
Oct. 24, 2024 (JP) 2024-187411

(51) Int. Cl. H04N 23/60; H04N 23/63; H04N 23/667; H04N 25/76

(52) U.S. Cl. CPC H04N 23/64; H04N 23/631; H04N 23/667; H04N 25/7795

(57) ABSTRACT

An image pickup apparatus capable of increasing the possibility of obtaining an image at the best timing while suppressing the capacity used in a recording medium is provided. In response to a start operation to start continuous photographing, the image pickup apparatus causes an image pickup device to execute an image pickup processing at a second photographing speed, and executes, based on a first photographing speed, a development processing by an image processing unit and a recording processing by an image recording unit with respect to image signals that have been obtained by the image pickup processing and have been retained in a volatile memory of an image obtaining unit.

### BACKGROUND

### Field of the Technology

The present disclosure relates to an image pickup apparatus, a control method for the image pickup apparatus, and a storage medium.

### Description of the Related Art

As an image pickup apparatus that is capable of realizing a photographer's request to want to obtain an image that has been photographed at the best timing, an image pickup apparatus having a pre-photographing function has been known. An image pickup apparatus having a pre-photographing function performs continuous photographing before a photographer performs a photographing operation, temporarily retains a plurality of digital image signals in a temporary storage memory within the image pickup apparatus, and records them on a recording medium when the photographing operation has been performed. Therefore, for example, in the case of photographing a subject whose movement is difficult to predict, even if the photographing operation is delayed from a desired timing, images are capable of being recorded on the recording medium by going back to a timing before the photographing operation, thereby increasing the possibility of obtaining an image at the best timing.

In addition, there may be a case where the photographer photographs a subject whose movement is difficult to predict and whose movement speed is very fast. In such a case, in order to increase the possibility of obtaining an image at the best timing, it is necessary to keep, as fast as possible, a photographing speed of the continuous photographing while the subject is moving, and to obtain images of as many timings as possible. As a related technique, a technique disclosed in Japanese Laid-Open Patent Publication (kokai) No. 2001-257925 has been proposed. In the technique disclosed in Japanese Laid-Open Patent Publication (kokai) No. 2001-257925, at a timing when a photographing operation has been performed, a photographing speed is switched to a speed higher (faster) than a photographing speed of pre-photographing that has been executed before the photographing operation is performed. As a result, it is possible to perform high-speed continuous photographing after the photographing operation while recording, on a recording medium, images, each of which has been photographed at a timing before the photographing operation.

However, in the technique disclosed in Japanese Laid-Open Patent Publication (kokai) No. 2001-257925, in the pre-photographing that has been executed before the photographing operation is performed, continuous photographing has not been performed at a high-speed photographing speed (at a high photographing speed). Generally, the faster the subject moves, the more likely it is that the timing at which the photographer performs the photographing operation is delayed from the intended timing, so with the pre-photographing described above, in the case of photographing a subject that moves very fast, there is a high possibility of missing an image at the best timing. In addition, if the continuous photographing is performed at a high photographing speed from the stage of the pre-photographing, the number of images recorded on the recording medium will increase, so there is a possibility that the recording medium will run out of capacity before an image at the best timing is recorded, and that contrariwise, the image at the best timing may be missed.

### SUMMARY

The present disclosure provides a technique that is capable of increasing the possibility of obtaining an image at the best timing while suppressing the capacity used in a recording medium.

Accordingly, a first aspect of the present disclosure provides an image pickup apparatus comprising an image sensor, a first operation member configured to accept, from a photographer, a start instruction to start continuous photographing, a second operation member configured to accept, from the photographer during the continuous photographing, a switching instruction to switch a photographing speed of the continuous photographing, and at least one processor or circuit and a memory storing instructions to cause the at least one processor or circuit to perform operations of the following units a retaining unit that temporarily retains image signals that have been obtained through an image pickup processing performed by the image sensor, a setting unit that sets a first photographing speed to be used in the continuous photographing, and a second photographing speed to be used as the photographing speed of the continuous photographing in accordance with the switching instruction, and a control unit that performs control of the continuous photographing. In accordance with the start instruction of the continuous photographing, the control unit causes the image sensor to execute the image pickup processing at a photographing speed equal to or faster than the second photographing speed, and executes, based on the first photographing speed, a development processing with respect to image signals that have been obtained by the image pickup processing and have been retained, and a processing of recording the processed image signals that have been obtained by the development processing on a recording medium. In accordance with the switching instruction, the control unit causes the image sensor to execute the image pickup processing at the second photographing speed, executes a development processing with respect to image signals that have been retained during a predetermined period going back from a time point when the switching instruction has been accepted and that have not yet been subjected to the development processing, and a processing of recording the processed image signals that have been obtained by the development processing on the recording medium, and executes, based on the second photographing speed, a development processing with respect to image signals that have been retained after the switching instruction, and a processing of recording the processed image signals that have been obtained by the development processing on the recording medium.

Accordingly, a second aspect of the present disclosure provides an image pickup apparatus comprising an image sensor, a first operation member configured to accept, from a photographer, a start instruction to start continuous photographing, a second operation member configured to accept, from the photographer during the continuous photographing, a switching instruction to switch a photographing speed of the continuous photographing, and at least one processor or circuit and a memory storing instructions to cause the at least one processor or circuit to perform operations of the following units a retaining unit that temporarily retains image signals that have been obtained through an image pickup processing performed by the image sensor, a first setting unit that sets a first photographing speed to be used in the continuous photographing, and a second photographing speed to be used as the photographing speed of the continuous photographing in accordance with the switching instruction, a second setting unit that sets a faster photographing speed out of the first photographing speed and the second photographing speed to a photographing speed at a start of the continuous photographing, and a control unit that performs control of the continuous photographing. In accordance with the start instruction of the continuous photographing, the control unit causes the image sensor to execute the image pickup processing at a photographing speed equal to or faster than the photographing speed that has been set by the second setting unit, and executes, based on the first photographing speed, a development processing with respect to image signals that have been obtained by the image pickup processing and have been retained, and a processing of recording the processed image signals that have been obtained by the development processing on a recording medium. In accordance with the switching instruction, the control unit causes the image sensor to execute the image pickup processing at the second photographing speed, executes a development processing with respect to image signals that have been retained during a predetermined period going back from a time point when the switching instruction has been accepted and that have not yet been subjected to the development processing, and a processing of recording the processed image signals that have been obtained by the development processing on the recording medium, and executes, based on the second photographing speed, a development processing with respect to image signals that have been retained after the switching instruction, and a processing of recording the processed image signals that have been obtained by the development processing on the recording medium.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that schematically illustrates a configuration of an image pickup apparatus according to a first embodiment.

FIG. 2 is a diagram that illustrates the timing relationship between image pickup control and development and recording control that are executed by a system control unit included in the image pickup apparatus shown in FIG. 1.

FIG. 3 is a flowchart that illustrates the procedure of a control processing executed by the image pickup apparatus shown in FIG. 1.

FIG. 4 is a diagram that illustrates the timing relationship between image pickup control and development and recording control that are executed by a system control unit included in an image pickup apparatus according to a second embodiment.

FIG. 5 is a flowchart that illustrates the procedure of a control processing executed by the image pickup apparatus according to the second embodiment.

### DESCRIPTION OF THE EMBODIMENTS

The present disclosure will now be described in detail below with reference to the accompanying drawings showing embodiments thereof.

Hereinafter, embodiments of the present disclosure will be described in detail with reference to the accompanying drawings. It should be noted that the following embodiments do not limit the invention as defined by the claims. Although the embodiments describe a plurality of features, not all of the plurality of features are essential to the present disclosure, and the plurality of features may be combined in any desired manner.

First, an image pickup apparatus and a control method therefor according to a first embodiment of the present disclosure will be described.

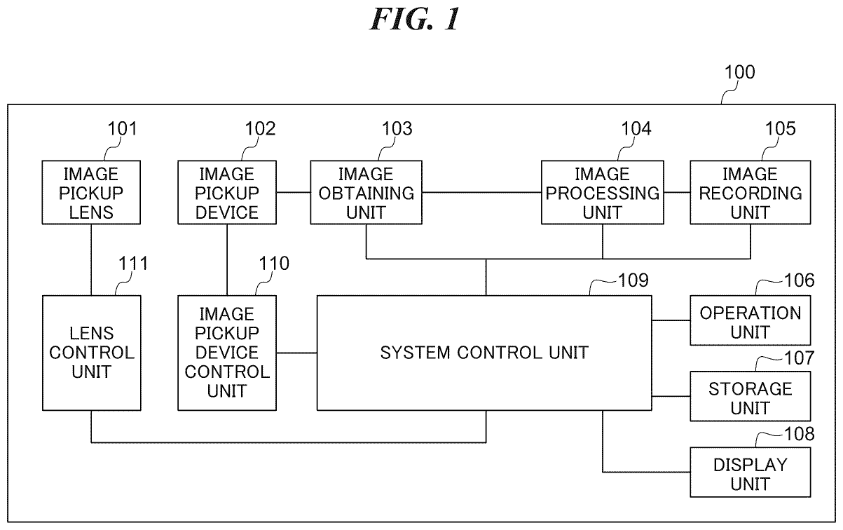

FIG. 1 is a block diagram that schematically illustrates a configuration of an image pickup apparatus 100 according to the first embodiment.

As shown in FIG. 1, the image pickup apparatus 100 includes an image pickup lens 101, an image pickup device 102 (an image sensor), an image obtaining unit 103, an image processing unit 104, an image recording unit 105, an operation unit 106, a storage unit 107, a display unit 108, a system control unit 109, an image pickup device control unit 110, and a lens control unit 111.

The image pickup lens 101 is an interchangeable lens unit that is capable of being attached to the main body portion of the image pickup apparatus 100, or a lens unit that has been incorporated in the main body portion, and includes a plurality of lens groups such as a focus lens and a zoom lens, an aperture mechanism, etc.

The image pickup device 102 is, for example, a CMOS image sensor configured to include a plurality of pixels. The image pickup device 102 performs photoelectric conversion at each pixel with respect to an optical image of a subject formed by the image pickup lens 101 to generate charges in accordance with the amount of incident light, applies a gain to each pixel, and outputs image signals. In addition, the image pickup device 102 has an electronic shutter function such as a rolling shutter, and is capable of controlling an exposure time.

The image obtaining unit 103 includes an A/D conversion mechanism that digitizes the image signals (analog signals) that have been outputted from the image pickup device 102, and a temporary storage medium such as a volatile memory, and temporarily retains the obtained digital image signals.

The image processing unit 104 performs various kinds of signal processing, such as a noise reduction processing, a gamma processing, a color signal processing, and an exposure correction processing, required for viewing an image, with respect to the digital image signals that have been retained in the image obtaining unit 103.

The image recording unit 105 records the image signals that have been processed by the image processing unit 104 on a recording medium. As the recording medium, for example, a memory device such as a hard disk or an SD card that is capable of being attached to the main body portion of the image pickup apparatus 100 is used.

The operation unit 106 accepts various types of operation instructions from a photographer with respect to the image pickup apparatus 100. The operation unit 106 includes a plurality of operation members such as a camera power button, a continuous photographing speed setting button, a release button, and a speed switching button. The release button is capable of being operated in two stages, depending on the status of pressing, such as half pressing or full pressing. An instruction that has been inputted via the operation unit 106 is notified to the system control unit 109 and is stored in the storage unit 107 as operation information.

The storage unit 107 is configured to include an electrically erasable and recordable volatile memory and a nonvolatile memory. The storage unit 107 stores software programs used by the system control unit 109, operation information based on information notified from the operation unit 106, setting information such as photographing speed settings before and after switching, and a setting of the number of pre-photographing images (a number-of-pre-photographing-images setting).

The display unit 108 is configured to include a thin film transistor liquid crystal display device (a TFT liquid crystal display device), a liquid crystal display device (an LCD device), or the like, and displays a still image photographing result, a live view image (an LV image), control information, etc. The control information is, for example, information such as sensor sensitivity, the exposure time, and an aperture value for exposure control. The TFT liquid crystal display device includes a touch panel mechanism, and is also capable of being used as an input mechanism for accepting various types of operations from the photographer together with the operation unit 106.

The system control unit 109 includes a computing mechanism for electronic control such as a central processing unit (a CPU). The system control unit 109 performs image pickup control of the image pickup apparatus 100 via the image pickup device control unit 110, the lens control unit 111, and the image obtaining unit 103 based on the software programs and the operation information that have been stored in the storage unit 107. In addition, the system control unit 109 performs development and recording control of the image pickup apparatus 100 via the image processing unit 104 and the image recording unit 105.

The image pickup device control unit 110 performs drive control of the image pickup device 102 in accordance with the control signal that has been received from the system control unit 109. The lens control unit 111 performs drive control of the image pickup lens 101 in accordance with the control signal that has been received from the system control unit 109.

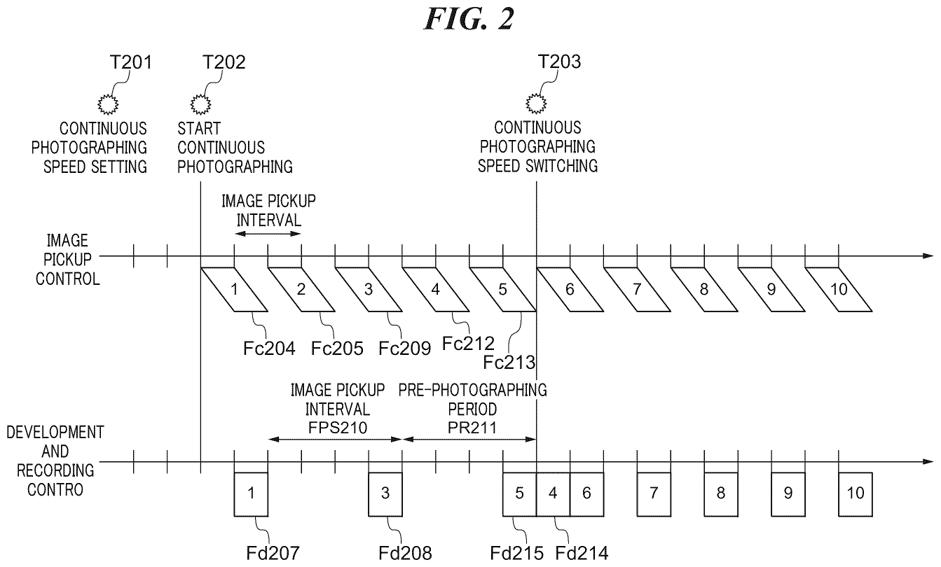

FIG. 2 is a diagram that illustrates the timing relationship between the image pickup control and the development and recording control that are executed by the system control unit 109 included in the image pickup apparatus 100 shown in FIG. 1.

As shown in FIG. 2, at an operation timing T201, the system control unit 109 performs a continuous photographing speed setting. Here, a first photographing speed and a second photographing speed are set. The first photographing speed is a photographing speed (hereinafter, referred to as “a photographing speed before switching”) to be used for continuous photographing that starts in response to full pressing of the release button on the operation unit 106 (in response to a photographing start instruction) at an operation timing T202 that will be described below. The second photographing speed is a photographing speed (hereinafter, referred to as “a photographing speed after switching”) to be used as a photographing speed of continuous photographing in response to pressing of the speed switching button on the operation unit 106 at an operation timing T203 that will be described below during continuous photographing at the first photographing speed. It should be noted that in the present embodiment, a configuration may be adopted in which a setting value of the first photographing speed and a setting value of the second photographing speed that have been stored in advance in the storage unit 107 are invoked, or a configuration may be adopted in which setting values of the photographing speed that have been selected by the photographer by using the continuous photographing speed setting button on the operation unit 106 are invoked. It should be noted that in the present embodiment, an example will be described in which the first photographing speed is set to 5 [fps], and the second photographing speed is set to 10 [fps], which is faster than the first photographing speed and is a multiple of the first photographing speed (the first photographing speed and the second photographing speed are in a multiple relationship).

At the operation timing T202, the continuous photographing is started in response to full pressing of the release button on the operation unit 106. The system control unit 109 performs the image pickup control at the second photographing speed. Specifically, the system control unit 109 controls the image pickup device control unit 110 to drive the image pickup device 102 at the second photographing speed and cause the image pickup device 102 to perform an image pickup processing at the second photographing speed. At this time, an image pickup interval FPS206 between a frame Fc204 and a frame Fc205, which are image signals continuously obtained from the image pickup device 102, is an interval based on the second photographing speed (10 [fps]) that has been set at the operation timing T201. The picked-up image signals are temporarily retained in the volatile memory of the image obtaining unit 103. In the present embodiment, as an example, the volatile memory of the image obtaining unit 103 is assumed to have a storage area capable of retaining data for ten frames. It should be noted that in the present embodiment, in order to prevent the volatile memory of the image obtaining unit 103 from running out of free space and becoming unable to write data to the volatile memory, the retained data is deleted in order from the oldest data at a predetermined cycle.

In addition, the system control unit 109 performs the development and recording control at the first photographing speed. Specifically, the system control unit 109 controls the image processing unit 104 to perform a development processing with respect to the image signals that have been retained in the volatile memory of the image obtaining unit 103. Furthermore, the system control unit 109 controls the image recording unit 105 to record, on the recording medium, the image signals, with respect to which the development processing has been performed. In FIG. 2, a frame Fd207 that is image signals, with respect to which the development processing has been performed, is obtained by subjecting the frame Fc204 to the development processing, and a frame Fd208 that is image signals, with respect to which the development processing has been performed, is obtained by subjecting a frame Fc209 to the development processing. The frame Fd207 and the frame Fd208 are recorded on the recording medium. Here, an image pickup interval FPS210 between the frame Fd207 and the frame Fd208 is an interval based on the first photographing speed (5 [fps]) that has been set at the operation timing T201. In this way, in the present embodiment, in response to full pressing of the release button on the operation unit 106, the image pickup control is performed at the second photographing speed, and the development and recording control is performed at the first photographing speed, which is slower than the second photographing speed. In other words, only some of a plurality of image signals that have been picked up in the continuous photographing started in response to full pressing of the release button on the operation unit 106 and have been retained in the volatile memory of the image obtaining unit 103, not all of the plurality of image signals, are developed and recorded on the recording medium.

At the operation timing T203, in response to pressing of the speed switching button on the operation unit 106, the system control unit 109 performs the development and recording control of frames that have been picked up during a pre-photographing period PR211 and have been retained in the volatile memory of the image obtaining unit 103, and speed switching control of the continuous photographing. The pre-photographing period PR211 is determined based on a setting value that has been stored in advance in the storage unit 107. This setting value is, for example, a number-of-pre-photographing-images setting that is a value indicating the number of images, and in the present embodiment, as an example, the number-of-pre-photographing-images setting is set to “2” (“2 images”). It should be noted that the setting value for determining the pre-photographing period PR211 is not limited to the number-of-pre-photographing-images setting, but may be determined based on a value indicating the length of the pre-photographing period. The system control unit 109 controls the image processing unit 104 and the image recording unit 105 to perform the development and recording control with respect to a frame Fc212 that has been picked up during the pre-photographing period PR211, has been retained in the volatile memory of the image obtaining unit 103, and with respect to which the development and recording control has not been performed. As a result, a frame Fd214 that is image signals, with respect to which the development processing has been performed, is recorded on the recording medium. After the operation timing T203 (after pressing of the speed switching button), the image pickup control is performed at the second photographing speed (10 [fps]) that has been set at the operation timing T201, and similarly, the development and recording control is performed at the second photographing speed.

By performing the image pickup control and the development and recording control as described above, it is possible to perform recording of images by going back to a timing before a continuous photographing speed switching operation (a timing before pressing of the speed switching button), thereby increasing the possibility of obtaining an image at the best timing.

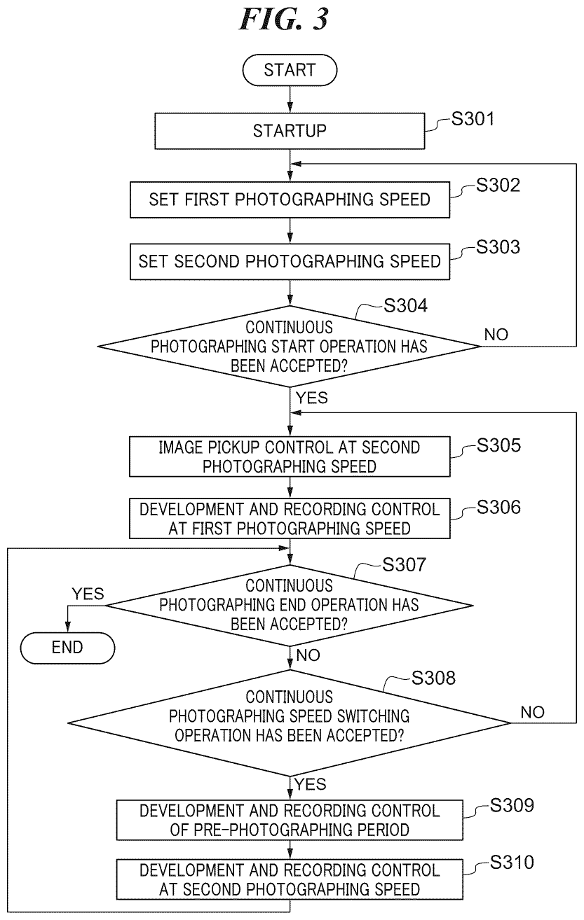

FIG. 3 is a flowchart that illustrates the procedure of a control processing executed by the image pickup apparatus 100 shown in FIG. 1. Respective processes (respective steps) indicated by S numbers in the flowchart of FIG. 3 are realized by the system control unit 109 executing a program that has been stored in the storage unit 107 and comprehensively controlling the operations of the respective units that constitute the image pickup apparatus 100.

As shown in FIG. 3, first, in S301, when the camera power button on the operation unit 106 is pressed, the system control unit 109 causes the image pickup apparatus 100 to be started up.

Next, in S302, the system control unit 109 sets a first photographing speed. Specifically, the system control unit 109 reads out a setting value that has been stored in advance as a program in the storage unit 107 or a setting value that has been set by the photographer by using the continuous photographing speed setting button on the operation unit 106, and sets the setting value that has been read out to the first photographing speed. It should be noted that in the present embodiment, as an example, it is assumed that 5 [fps] has been set to the first photographing speed.

Next, in S303, the system control unit 109 sets a second photographing speed. Also in S303, similar to S302, the system control unit 109 reads out a setting value that has been stored in advance as a program in the storage unit 107 or a setting value that has been set by the photographer by using the continuous photographing speed setting button on the operation unit 106, and sets the setting value that has been read out to the second photographing speed. It should be noted that in the present embodiment, as an example, it is assumed that 10 [fps] has been set to the second photographing speed.

Next, in S304, the system control unit 109 determines whether or not a continuous photographing start operation has been accepted. In the present embodiment, in the case where the photographer has performed full pressing of the release button on the operation unit 106, this operation information is stored in the storage unit 107. The system control unit 109 determines whether or not a continuous photographing start operation has been accepted based on the presence or absence of this operation information. In the case of being determined that a continuous photographing start operation has not been accepted (NO in S304), the control processing returns to S302. On the other hand, in the case of being determined that a continuous photographing start operation has been accepted (YES in S304), the control processing proceeds to S305.

In S305, the system control unit 109 controls the image pickup device control unit 110 to start image pickup control at the second photographing speed that has been set in S303. In this image pickup control, the image pickup device 102 performs an image pickup processing at the second photographing speed, and performs obtainment of frames at an image pickup interval based on the second photographing speed (10 [fps]). The obtained frames are retained as digital image signals in the volatile memory of the image obtaining unit 103.

Next, in S306, the system control unit 109 controls the image processing unit 104 to start development and recording control at the first photographing speed that has been set in S302. In the present embodiment, as described above with reference to FIG. 2, from the frames that have been picked up at an image pickup interval based on 10 [fps] and have been retained in the image obtaining unit 103, frames to be processed at an interval based on 5 [fps] are selected. The image processing unit 104 performs the development processing with respect to the selected frames, and the image recording unit 105 records, on the recording medium, the frames, with respect to which the development processing has been performed. It should be noted that the processing for the frames that have not been selected is skipped while the frames that have not been selected have been retained in the image obtaining unit 103.

Next, in S307, the system control unit 109 determines whether or not a continuous photographing end operation has been accepted. In the present embodiment, in the case where the photographer has released full pressing of the release button on the operation unit 106, for example, the operation information that has been stored in the storage unit 107 in S304 is deleted. The system control unit 109 determines whether or not a continuous photographing end operation has been accepted based on the presence or absence of this operation information. In the case of being determined that a continuous photographing end operation has been accepted (YES in S307), the control processing ends. On the other hand, in the case of being determined that a continuous photographing end operation has not been accepted (NO in S307), the control processing proceeds to S308.

In S308, the system control unit 109 determines whether or not a continuous photographing speed switching operation (a switching instruction to switch the photographing speed of the continuous photographing) has been accepted. In the present embodiment, in the case where the photographer has pressed the speed switching button on the operation unit 106, this operation information is stored in the storage unit 107. The system control unit 109 determines whether or not a continuous photographing speed switching operation has been accepted based on the presence or absence of this operation information. In the case of being determined that a continuous photographing speed switching operation has not been accepted (NO in S308), the control processing returns to S305. On the other hand, in the case of being determined that a continuous photographing speed switching operation has been accepted (YES in S308), the control processing proceeds to S309.

In S309, the system control unit 109 performs the development and recording control of a pre-photographing period. Specifically, the system control unit 109 reads out the number-of-pre-photographing-images setting from the storage unit 107. In the present embodiment, as an example, the number-of-pre-photographing-images setting is set to “2” (“2 images”). The system control unit 109 performs the development processing by the image processing unit 104 and the recording processing by the image recording unit 105 with respect to a frame, the development and recording control for which has been skipped in S306, out of two frames that have been picked up during the pre-photographing period and have been retained in the volatile memory of the image obtaining unit 103. It should be noted that the pre-photographing period is a period going back from a time point when the photographer has pressed the speed switching button, and the length of the pre-photographing period is determined based on the number-of-pre-photographing-images setting. Here, as an example, a case will be described in which, in S305, as shown in FIG. 2, five frames, namely, the frame Fc204, the frame Fc205, the frame Fc209, the frame Fc212, and a frame Fc213, have been retained in the volatile memory of the image obtaining unit 103. In this case, in S306, the development and recording control is performed with respect to the frame Fc204, the frame Fc209, and the frame Fc213 out of these five frames. It should be noted that the processing for the frame Fc205 and the frame Fc212 where the development and recording control has not been performed is skipped while the frame Fc205 and the frame Fc212 where the development and recording control has not been performed have been retained in the volatile memory of the image obtaining unit 103. In addition, in S309, with respect to the frame Fc212 that has been picked up during the pre-photographing period PR211, has been retained in the volatile memory of the image obtaining unit 103, and the development and recording control for which has been skipped in S306, the development processing by the image processing unit 104 and the recording processing by the image recording unit 105 are performed. As a result, the frame Fd214 that is image signals of the frame Fc212, with respect to which the development processing has been performed, is recorded on the recording medium.

Next, in S310, the system control unit 109 controls the image processing unit 104 to start development and recording control at the second photographing speed that has been set in S303. In this development and recording control, the image processing unit 104 performs the development processing at an interval based on 10 [fps] with respect to frames that have been retained in the volatile memory of the image obtaining unit 103 after the continuous photographing speed switching operation (after the switching instruction). In addition, the image recording unit 105 records, on the recording medium, the frames, with respect to which the development processing has been performed at the same interval. Thereafter, the control processing returns to S307.

According to the first embodiment described above, in response to the continuous photographing start operation, the image pickup device 102 executes the image pickup processing at the second photographing speed. The image processing unit 104 performs the development processing with respect to the frame Fc204, the frame Fc209, and the frame Fc213 that have been obtained through the image pickup processing and have been retained in the volatile memory of the image obtaining unit 103, based on the first photographing speed. The image recording unit 105 records, on the recording medium, the frame Fd207, the frame Fd208, and a frame Fd215 that have been subjected to the development processing based on the first photographing speed. As a result, in response to the continuous photographing start operation, while limiting the number of images to be recorded on the recording medium to the number of images based on the first photographing speed, images whose number is the number of images based on the second photographing speed, which is the photographing speed after switching, are capable of being retained in the volatile memory of the image obtaining unit 103 as images at the timing before the continuous photographing speed switching operation. In addition, in response to the continuous photographing speed switching operation, the image pickup device 102 executes the image pickup processing at the second photographing speed. The image processing unit 104 performs the development processing with respect to the frame Fc212 that has been retained in the pre-photographing period PR211 going back from a time point when the continuous photographing speed switching operation has been accepted and that has not yet been subjected to the development processing. The image recording unit 105 records, on the recording medium, the development-processed frame Fd214 that has been obtained through this development processing. In addition, the image processing unit 104 performs the development processing with respect to the frames that have been retained after the continuous photographing speed switching operation, based on the second photographing speed. The image recording unit 105 records, on the recording medium, the development-processed frames that have been obtained through the development processing based on the second photographing speed. As a result, it becomes possible to realize pre-photographing that continues until a time point when the continuous photographing speed switching operation has been accepted while limiting the number of images to be recorded on the recording medium before the continuous photographing speed switching operation to the number of images based on the first photographing speed. In other words, in the above-described embodiment, it is possible to increase the possibility of obtaining an image at the best timing while suppressing the capacity used in the recording medium.

In addition, in the first embodiment described above, the pre-photographing period PR211 is determined based on the setting value that has been stored in advance in the storage unit 107. As a result, without forcing the photographer to perform a setting for the pre-photographing period PR211, it is possible to increase the possibility of obtaining an image at the best timing while suppressing the capacity used in the recording medium.

It should be noted that in the control processing shown in FIG. 3 that has been described above, the configuration, in which the image pickup control is performed at the second photographing speed in S305, has been described, but the present disclosure is not limited to this configuration. For example, in the case where the image pickup apparatus 100 is capable of performing the image pickup control at a third photographing speed that is faster than the second photographing speed, the image pickup control may be performed at the third photographing speed in S305. Even with such a configuration, it is possible to achieve the same effects as those of the above-described embodiment.

Next, an image pickup apparatus and a control method therefor according to a second embodiment of the present disclosure will be described.

The second embodiment is basically the same as the first embodiment described above in terms of configuration and operation, but differs from the first embodiment described above in that in continuous photographing, there are a plurality of pre-photographing periods. Therefore, descriptions of duplicate configurations and duplicate operations will be omitted, and only different configurations and different operations will be described below.

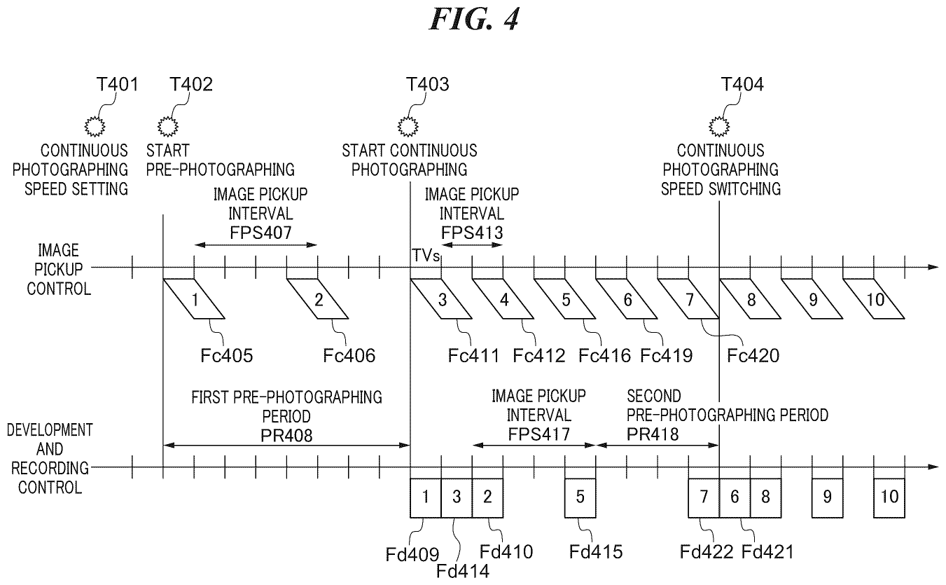

FIG. 4 is a diagram that illustrates the timing relationship between image pickup control and development and recording control that are executed by a system control unit 109 included in the image pickup apparatus according to the second embodiment.

As shown in FIG. 4, at an operation timing T401, the system control unit 109 performs a continuous photographing speed setting. Here, similar to the operation timing T201 shown in FIG. 2 described above, a first photographing speed and a second photographing speed are set. It should be noted that also in the second embodiment, a configuration may be adopted in which a setting value of the first photographing speed and a setting value of the second photographing speed that have been stored in advance in the storage unit 107 are invoked, or a configuration may be adopted in which setting values of the photographing speed that have been selected by the photographer by using the continuous photographing speed setting button on the operation unit 106 are invoked. Also in the second embodiment, an example will be described in which the first photographing speed is set to 5 [fps], and the second photographing speed is set to 10 [fps], which is faster than the first photographing speed and is a multiple of the first photographing speed (the first photographing speed and the second photographing speed are in a multiple relationship).

At an operation timing T402, pre-photographing is started in response to half pressing of the release button on the operation unit 106. The system control unit 109 controls the image pickup device control unit 110 to drive the image pickup device 102 at the first photographing speed and cause the image pickup device 102 to perform an image pickup processing at the first photographing speed. At this time, an image pickup interval FPS407 between a frame Fc405 and a frame Fc406, which are image signals continuously obtained from the image pickup device 102, is an interval based on the first photographing speed (5 [fps]) that has been set at the operation timing T401. The image signals that have been picked up in the pre-photographing are retained in the volatile memory of the image obtaining unit 103.

At an operation timing T403, in response to full pressing of the release button on the operation unit 106, development and recording control of a first pre-photographing period PR408 is started. The first pre-photographing period PR408 is determined based on a first setting value that has been stored in advance in the storage unit 107. Similar to the setting value in the first embodiment described above, the first setting value is the number-of-pre-photographing-images setting, or the first setting value is a value indicating the length of the pre-photographing period. In the second embodiment, as an example, the number-of-pre-photographing-images setting serving as the first setting value is set to “2” (“2 images”). The system control unit 109 controls the image processing unit 104 to perform a development processing with respect to the image signals that have been retained in the volatile memory of the image obtaining unit 103, and controls the image recording unit 105 to record, on the recording medium, the image signals, with respect to which the development processing has been performed. In FIG. 4, a frame Fd409 that is image signals, with respect to which the development processing has been performed, is obtained by subjecting the frame Fc405 to the development processing, and a frame Fd410 that is image signals, with respect to which the development processing has been performed, is obtained by subjecting the frame Fc406 to the development processing. The frame Fd409 and the frame Fd410 are recorded on the recording medium.

In addition, at the operation timing T403, continuous photographing is started in response to full pressing of the release button on the operation unit 106. The system control unit 109 performs the image pickup control at the second photographing speed. Specifically, the system control unit 109 controls the image pickup device control unit 110 to drive the image pickup device 102 at a faster photographing speed out of the first photographing speed and the second photographing speed and cause the image pickup device 102 to perform an image pickup processing at the faster photographing speed. Here, it is assumed that the image pickup device 102 is driven at the second photographing speed. At this time, an image pickup interval FPS413 between a frame Fc411 and a frame Fc412, which are image signals continuously obtained from the image pickup device 102, is an interval based on the second photographing speed (10 [fps]) that has been set at the operation timing T401. The picked-up image signals are retained in the volatile memory of the image obtaining unit 103. In addition, the system control unit 109 performs the development and recording control at the first photographing speed. Specifically, the system control unit 109 controls the image processing unit 104 to perform a development processing with respect to the image signals that have been retained in the volatile memory of the image obtaining unit 103, and controls the image recording unit 105 to record, on the recording medium, the image signals, with respect to which the development processing has been performed. In FIG. 4, a frame Fd414 that is image signals, with respect to which the development processing has been performed, is obtained by subjecting the frame Fc411 to the development processing, and a frame Fd415 that is image signals, with respect to which the development processing has been performed, is obtained by subjecting a frame Fc416 to the development processing. The frame Fd414 and the frame Fd415 are recorded on the recording medium. Here, an image pickup interval FPS417 between the frame Fd414 and the frame Fd415 is an interval based on the first photographing speed (5 [fps]) that has been set at the operation timing T401. Thereafter, until the speed switching button on the operation unit 106 is pressed, the image pickup control is performed at the second photographing speed, and the development and recording control is performed at the first photographing speed.

At an operation timing T404, in response to pressing of the speed switching button on the operation unit 106, the system control unit 109 performs the development and recording control of a second pre-photographing period, and switching control of the photographing speed. A second pre-photographing period PR418 is determined based on a second setting value that has been stored in advance in the storage unit 107. Similar to the first setting value described above, the second setting value is the number-of-pre-photographing-images setting, or the second setting value is a value indicating the length of the pre-photographing period. In the second embodiment, as an example, the number-of-pre-photographing-images setting serving as the second setting value is set to “2” (“2 images”). It should be noted that in the second embodiment, for ease of description, the first setting value and the second setting value have been described as being the same value, but they may be different values, for example, the first setting value may be set to “2” (“2 images”) and the second setting value may be set to “3” (“3 images”). The system control unit 109 controls the image processing unit 104 and the image recording unit 105 to perform the development and recording control with respect to a frame Fc419 that has been picked up during the second pre-photographing period PR418, has been retained in the volatile memory of the image obtaining unit 103, and with respect to which the development and recording control has not been performed. As a result, a frame Fd421, which is image signals obtained by subjecting the frame Fc419 to the development processing, is recorded on the recording medium. After the operation timing T404 (after pressing of the speed switching button), the image pickup control is performed at the second photographing speed (10 [fps]) that has been set at the operation timing T401, and the development and recording control is performed at the second photographing speed.

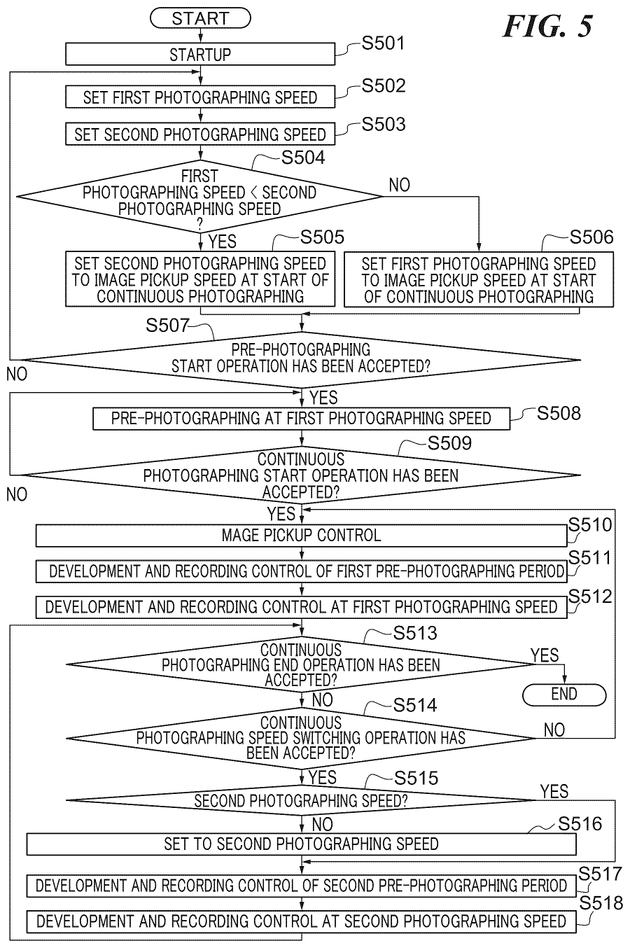

FIG. 5 is a flowchart that illustrates the procedure of a control processing executed by an image pickup apparatus 100 according to the second embodiment. It should be noted that the control processing shown in FIG. 5 is a processing similar to the control processing shown in FIG. 3 described above, and the following will particularly describe the differences from the control processing shown in FIG. 3 described above. Respective processes (respective steps) indicated by S numbers in the flowchart of FIG. 5 are realized by the system control unit 109 executing a program that has been stored in the storage unit 107 and comprehensively controlling the operations of the respective units that constitute the image pickup apparatus 100.

As shown in FIG. 5, first, S501 to S503, which are the same processes as S301 to S303 that have been described above, are performed. Also in the second embodiment, as an example, similar to the control processing shown in FIG. 3 described above, it is assumed that 5 [fps] has been set to the first photographing speed and 10 [fps] has been set to the second photographing speed.

Next, in S504, the system control unit 109 determines whether or not the second photographing speed is faster than the first photographing speed. In the case of being determined that the second photographing speed is faster than the first photographing speed (YES in S504), the control processing shown in FIG. 5 proceeds to S505. On the other hand, in the case of being determined that the second photographing speed is not faster than the first photographing speed, that is, in the case of being determined that the second photographing speed is equal to or lower than the first photographing speed (NO in S504), the control processing shown in FIG. 5 proceeds to S506.

In S505, the system control unit 109 sets an image pickup speed (a photographing speed) at the start of continuous photographing to the second photographing speed. Next, the control processing shown in FIG. 5 proceeds to S507.

In S506, the system control unit 109 sets the image pickup speed at the start of continuous photographing to the first photographing speed. In this way, in the second embodiment, the faster photographing speed out of the first photographing speed and the second photographing speed is set as the image pickup speed at the start of continuous photographing. Next, the control processing shown in FIG. 5 proceeds to S507.

In S507, the system control unit 109 determines whether or not a pre-photographing start operation has been accepted. In the second embodiment, in the case where the photographer has performed half pressing of the release button on the operation unit 106, this operation information is stored in the storage unit 107. The system control unit 109 determines whether or not a pre-photographing start operation has been accepted based on the presence or absence of this operation information. In the case of being determined that a pre-photographing start operation has not been accepted (NO in S507), the control processing shown in FIG. 5 returns to S502. On the other hand, in the case of being determined that a pre-photographing start operation has been accepted (YES in S507), the control processing shown in FIG. 5 proceeds to S508.

In S508, the system control unit 109 controls the image pickup device control unit 110 to start image pickup control at the first photographing speed that has been set in S502. In this image pickup control, the image pickup device 102 performs an image pickup processing at the first photographing speed, and performs obtainment of frames at an image pickup interval based on the first photographing speed (5 [fps]). The obtained frames (for example, the frame Fc405 and the frame Fc406 that are shown in FIG. 4) are retained as digital image signals in the volatile memory of the image obtaining unit 103.

Next, in S509, the system control unit 109 determines whether or not a continuous photographing start operation has been accepted. It should be noted that the determination method in S509 is the same as that in S304 described above. In the case of being determined that a continuous photographing start operation has not been accepted (NO in S509), the control processing shown in FIG. 5 returns to S508. On the other hand, in the case of being determined that a continuous photographing start operation has been accepted (YES in S509), the control processing shown in FIG. 5 proceeds to S510.

In S510, the system control unit 109 controls the image pickup device control unit 110 to start image pickup control of the image pickup device 102 at the image pickup speed at the start of continuous photographing that has been set in S505 or S506. In the second embodiment, frames are obtained at an image pickup interval based on the faster photographing speed (10 [fps]) out of the first photographing speed (5 [fps]) and the second photographing speed (10 [fps]). The obtained frames (for example, the frame Fc411, the frame Fc412, the frame Fc416, the frame Fc419, and a frame Fc420 that are shown in FIG. 4) are retained as digital image signals in the volatile memory of the image obtaining unit 103.

Next, in S511, the system control unit 109 performs the development and recording control of the first pre-photographing period PR408. Specifically, the system control unit 109 reads out the first setting value from the storage unit 107. In the second embodiment, as an example, the number-of-pre-photographing-images setting serving as the first setting value is set to “2” (“2 images”). The system control unit 109 controls the image processing unit 104 to perform a development processing with respect to frames that have been picked up during the first pre-photographing period PR408 and have been retained in the volatile memory of the image obtaining unit 103. In addition, the system control unit 109 controls the image recording unit 105 to record, on the recording medium, the development-processed frames that have been obtained through the development processing. It should be noted that the first pre-photographing period PR408 is a period going back from a time point when the photographer has performed full pressing of the release button, and the length of the first pre-photographing period PR408 is determined based on the first setting value. Here, as an example, a case will be described in which, in S508, as shown in FIG. 4, two frames, the frame Fc405 and the frame Fc406, have been retained in the volatile memory of the image obtaining unit 103. In this case, in S511, the development and recording control is performed with respect to the frame Fc405 and the frame Fc406. As a result, the frame Fd409 obtained by subjecting the frame Fc405 to the development processing, and the frame Fd410 obtained by subjecting the frame Fc406 to the development processing are recorded on the recording medium.

Next, in S512, the system control unit 109 controls the image processing unit 104 to start development and recording control at the first photographing speed that has been set in S502. In the second embodiment, from a plurality of frames that have been picked up at 10 [fps] in S510 and have been retained in the volatile memory of the image obtaining unit 103, frames to be processed at an interval based on 5 [fps] are selected. For example, in FIG. 4, from among the frames Fc411, Fc412, Fc416, Fc419, and Fc420 that have been retained in the volatile memory of the image obtaining unit 103 in S510, the frames Fc411, Fc416, and Fc420 are selected. In addition, the image processing unit 104 performs the development processing with respect to the selected frames Fc411, Fc416, and Fc420, respectively, and the image recording unit 105 records, on the recording medium, the frames Fd414, Fd415, and Fd422 that have been obtained by the development processing, respectively. It should be noted that the processing for the frame Fc412 and the frame Fc419 that have not been selected is skipped while the frame Fc412 and the frame Fc419 that have not been selected have been retained in the volatile memory of the image obtaining unit 103.

Next, in S513, the system control unit 109 determines whether or not a continuous photographing end operation has been accepted. It should be noted that the determination method in S513 is the same as that in S307 described above. In the case of being determined that a continuous photographing end operation has been accepted (YES in S513), the control processing shown in FIG. 5 ends. On the other hand, in the case of being determined that a continuous photographing end operation has not been accepted (NO in S513), the control processing shown in FIG. 5 proceeds to S514.

In S514, the system control unit 109 determines whether or not a continuous photographing speed switching operation has been accepted. It should be noted that the determination method in S514 is the same as that in S308 described above. In the case of being determined that a continuous photographing speed switching operation has not been accepted (NO in S514), the control processing shown in FIG. 5 returns to S510. On the other hand, in the case of being determined that a continuous photographing speed switching operation has been accepted (YES in S514), the control processing shown in FIG. 5 proceeds to S515.

In S515, the system control unit 109 determines whether or not the photographing speed of the continuous photographing is the second photographing speed. In the case of being determined that the photographing speed of the continuous photographing is the second photographing speed (YES in S515), the control processing shown in FIG. 5 proceeds to S517 that will be described below. On the other hand, in the case of being determined that the photographing speed of the continuous photographing is not the second photographing speed (NO in S515), the control processing shown in FIG. 5 proceeds to S516.

In S516, the system control unit 109 sets the photographing speed of the continuous photographing to the second photographing speed. As a result, the system control unit 109 controls the image pickup device control unit 110 to start image pickup control at the second photographing speed.

Next, in S517, the system control unit 109 performs the development and recording control of the second pre-photographing period PR418. Specifically, the system control unit 109 reads out the second setting value from the storage unit 107. In the second embodiment, as an example, the number-of-pre-photographing-images setting serving as the second setting value is set to “2” (“2 images”). The system control unit 109 controls the image processing unit 104 to perform a development processing with respect to a frame, the processing for which has been skipped in S512, out of two frames that have been picked up during the second pre-photographing period PR418 and have been retained in the volatile memory of the image obtaining unit 103. In addition, the system control unit 109 controls the image recording unit 105 to record, on the recording medium, the development-processed frame that has been obtained through the development processing. It should be noted that the second pre-photographing period PR418 is a period going back from a time point when the photographer has pressed the speed switching button, and the length of the second pre-photographing period PR418 is determined based on the second setting value. Here, in the example of FIG. 4, the frame Fc419, the processing for which has been skipped in S512, out of the frame Fc419 and the frame Fc420 that have been picked up during the second pre-photographing period PR418 and have been retained in the volatile memory of the image obtaining unit 103, has been subjected to the development processing. In addition, the development-processed frame Fd421 that has been obtained through the development processing is recorded on the recording medium.

Next, in S518, the system control unit 109 controls the image processing unit 104 to start development and recording control at the second photographing speed that has been set in S503. In the second embodiment, at an interval based on 10 [fps], the development processing by the image processing unit 104 and the recording processing by the image recording unit 105 are performed. Thereafter, the control processing shown in FIG. 5 returns to S513.

In the second embodiment described above, in response to the continuous photographing start operation, the image pickup device 102 executes the image pickup processing at the faster photographing speed out of the first photographing speed and the second photographing speed. The image processing unit 104 performs the development processing with respect to each of the frames Fc411, Fc416, and Fc420 corresponding to the image pickup interval based on the first photographing speed, from among the frames Fc411, Fc412, Fc416, Fc419, and Fc420 that have been obtained by the image pickup processing and have been retained in the volatile memory of the image obtaining unit 103. The image recording unit 105 records, on the recording medium, the development-processed frames Fd414, Fd415, and Fd422 that have been obtained by the development processing, respectively. As a result, in response to the continuous photographing start operation, while limiting the number of images to be recorded on the recording medium to the number of images based on the first photographing speed, images whose number is the number of images based on a photographing speed equal to or faster than the photographing speed after switching, are capable of being retained in the volatile memory of the image obtaining unit 103 as images at the timing before the continuous photographing speed switching operation. In addition, in response to the continuous photographing speed switching operation, the image pickup device 102 executes the image pickup processing at the second photographing speed. The image processing unit 104 performs the development processing with respect to the frame Fc419 that has been retained in the second pre-photographing period PR418 going back from a time point when the continuous photographing speed switching operation has been accepted and that has not yet been subjected to the development processing. The image recording unit 105 records, on the recording medium, the development-processed frame Fd421 that has been obtained through the development processing. Furthermore, with respect to the frames that have been retained after the continuous photographing speed switching operation, the development processing by the image processing unit 104 and the recording processing by the image recording unit 105 are performed based on the second photographing speed. As a result, it becomes possible to realize pre-photographing that continues until a time point when the continuous photographing speed switching operation has been accepted while limiting the number of images to be recorded on the recording medium before the continuous photographing speed switching operation to the number of images based on the first photographing speed. In other words, in the second embodiment described above, it is possible to increase the possibility of obtaining an image at the best timing while suppressing the capacity used in the recording medium.

In addition, in the second embodiment described above, in response to the pre-photographing start operation, the image pickup device 102 executes the image pickup processing at the first photographing speed. In response to the continuous photographing start operation, the development processing with respect to the frame Fc405 and the frame Fc406 that have been retained during the first pre-photographing period PR408, and the processing of recording the processed frames Fd409 and Fd410 that have been obtained by the development processing on the recording medium, are performed. As a result, in addition to the pre-photographing that continues until the time point when the continuous photographing speed switching operation has been accepted, it is also possible to realize pre-photographing that continues until a time point when the continuous photographing start operation has been accepted. As a result, it is possible to obtain images at more timings, and therefore, it is possible to further increase the possibility of obtaining an image at the best timing.

It should be noted that in the control processing shown in FIG. 5 that has been described above, the configuration, in which the pre-photographing is performed at the first photographing speed in S508, has been described, but the present disclosure is not limited to this configuration. For example, the pre-photographing may be performed at a photographing speed that is faster than the first photographing speed.

In addition, in the control processing shown in FIG. 5 that has been described above, the configuration, in which in S505 or S506, the faster photographing speed out of the first photographing speed and the second photographing speed is set as the image pickup speed at the start of continuous photographing, has been described, but the present disclosure is not limited to this configuration. For example, in the case where the image pickup apparatus 100 is capable of performing the image pickup control at a third photographing speed that is faster than both the first photographing speed and the second photographing speed, the image pickup control may be performed at the third photographing speed in S505 or S506. Even with such a configuration, it is possible to achieve the same effects as those of the above-described embodiment.

In addition, in the control processing shown in FIG. 5 that has been described above, a configuration may be adopted in which S504 to S506 are not performed, and in S510, the image pickup control is performed at the second photographing speed.

In addition, in the control processing shown in FIG. 5 that has been described above, in the case where the image pickup apparatus 100 is capable of performing the image pickup control at the third photographing speed that is faster than both the first photographing speed and the second photographing speed, a configuration may be adopted in which S504 to S506 are not performed, and in S510, the image pickup control is performed at the third photographing speed.

It should be noted that in the present embodiment, the image pickup apparatus 100 may be provided with a user interface (a UI) or the like that allows the photographer to select whether or not to retain, in the volatile memory of the image obtaining unit 103, the image signals that have been obtained through the image pickup processing performed by the image pickup device 102. As a result, it is possible to realize the pre-photographing only in scenes desired by the photographer, and therefore, it is possible to suppress a shortage of capacity of the volatile memory of the image obtaining unit 103 due to the pre-photographing.

According to the present disclosure, it is possible to increase the possibility of obtaining an image at the best timing while suppressing the capacity used in the recording medium.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-187411, filed Oct. 24, 2024, which is hereby incorporated by reference herein in its entirety.

What is claimed is:

1. An image pickup apparatus comprising:
an image sensor;
a first operation member configured to accept, from a photographer, a start instruction to start continuous photographing;
a second operation member configured to accept, from the photographer during the continuous photographing, a switching instruction to switch a photographing speed of the continuous photographing; and
at least one processor or circuit and a memory storing instructions to cause the at least one processor or circuit to perform operations of the following units:
a retaining unit that temporarily retains image signals that have been obtained through an image pickup processing performed by the image sensor;
a setting unit that sets a first photographing speed to be used in the continuous photographing, and a second photographing speed to be used as the photographing speed of the continuous photographing in accordance with the switching instruction; and
a control unit that performs control of the continuous photographing, and
wherein in accordance with the start instruction of the continuous photographing, the control unit causes the image sensor to execute the image pickup processing at a photographing speed equal to or faster than the second photographing speed, and executes, based on the first photographing speed, a development processing with respect to image signals that have been obtained by the image pickup processing and have been retained, and a processing of recording the processed image signals that have been obtained by the development processing on a recording medium, and
in accordance with the switching instruction, the control unit causes the image sensor to execute the image pickup processing at the second photographing speed, executes a development processing with respect to image signals that have been retained during a predetermined period going back from a time point when the switching instruction has been accepted and that have not yet been subjected to the development processing, and a processing of recording the processed image signals that have been obtained by the development processing on the recording medium, and executes, based on the second photographing speed, a development processing with respect to image signals that have been retained after the switching instruction, and a processing of recording the processed image signals that have been obtained by the development processing on the recording medium.

2. An image pickup apparatus comprising:
an image sensor;
a first operation member configured to accept, from a photographer, a start instruction to start continuous photographing;
a second operation member configured to accept, from the photographer during the continuous photographing, a switching instruction to switch a photographing speed of the continuous photographing; and
at least one processor or circuit and a memory storing instructions to cause the at least one processor or circuit to perform operations of the following units:
a retaining unit that temporarily retains image signals that have been obtained through an image pickup processing performed by the image sensor;
a first setting unit that sets a first photographing speed to be used in the continuous photographing, and a second photographing speed to be used as the photographing speed of the continuous photographing in accordance with the switching instruction;
a second setting unit that sets a faster photographing speed out of the first photographing speed and the second photographing speed to a photographing speed at a start of the continuous photographing; and
a control unit that performs control of the continuous photographing, and
wherein in accordance with the start instruction of the continuous photographing, the control unit causes the image sensor to execute the image pickup processing at a photographing speed equal to or faster than the photographing speed that has been set by the second setting unit, and executes, based on the first photographing speed, a development processing with respect to image signals that have been obtained by the image pickup processing and have been retained, and a processing of recording the processed image signals that have been obtained by the development processing on a recording medium, and
in accordance with the switching instruction, the control unit causes the image sensor to execute the image pickup processing at the second photographing speed, executes a development processing with respect to image signals that have been retained during a predetermined period going back from a time point when the switching instruction has been accepted and that have not yet been subjected to the development processing, and a processing of recording the processed image signals that have been obtained by the development processing on the recording medium, and executes, based on the second photographing speed, a development processing with respect to image signals that have been retained after the switching instruction, and a processing of recording the processed image signals that have been obtained by the development processing on the recording medium.

3. The image pickup apparatus according to claim 1, wherein
in accordance with a predetermined instruction that has been accepted before accepting the start instruction of the continuous photographing, the control unit causes the image sensor to execute the image pickup processing at a photographing speed equal to or faster than the first photographing speed, and
in accordance with the start instruction of the continuous photographing, the control unit further executes a development processing with respect to image signals that have been retained during another period going back from a time point when the predetermined instruction has been accepted, and a processing of recording the processed image signals that have been obtained by the development processing on the recording medium.

4. The image pickup apparatus according to claim 2, wherein
in accordance with a predetermined instruction that has been accepted before accepting the start instruction of the continuous photographing, the control unit causes the image sensor to execute the image pickup processing at a photographing speed equal to or faster than the first photographing speed, and
in accordance with the start instruction of the continuous photographing, the control unit further executes a development processing with respect to image signals that have been retained during another period going back from a time point when the predetermined instruction has been accepted, and a processing of recording the processed image signals that have been obtained by the development processing on the recording medium.

5. The image pickup apparatus according to claim 1, wherein
the at least one processor or circuit is caused to further perform operations of a selecting unit that allows the photographer to select whether or not to retain, in the retaining unit, image signals that have been obtained through the image pickup processing performed by the image sensor.

6. The image pickup apparatus according to claim 2, wherein
the at least one processor or circuit is caused to further perform operations of a selecting unit that allows the photographer to select whether or not to retain, in the retaining unit, image signals that have been obtained through the image pickup processing performed by the image sensor.

7. The image pickup apparatus according to claim 1, wherein
the predetermined period is determined based on a setting value that has been stored in advance.

8. The image pickup apparatus according to claim 2, wherein
the predetermined period is determined based on a setting value that has been stored in advance.

9. The image pickup apparatus according to claim 7, wherein
the setting value is a value that indicates a length of the predetermined period.

10. The image pickup apparatus according to claim 8, wherein
the setting value is a value that indicates a length of the predetermined period.

11. The image pickup apparatus according to claim 7, wherein
the setting value is a value that indicates the number of images.

12. The image pickup apparatus according to claim 8, wherein
the setting value is a value that indicates the number of images.

13. The image pickup apparatus according to claim 1, wherein
the first photographing speed and the second photographing speed are in a multiple relationship.

14. The image pickup apparatus according to claim 2, wherein
the first photographing speed and the second photographing speed are in a multiple relationship.

15. A control method for an image pickup apparatus that comprises an image sensor and a retaining unit configured to temporarily retain image signals that have been obtained through an image pickup processing performed by the image sensor, the control method comprising:
a first accepting step of accepting, from a photographer, a start instruction to start continuous photographing;
a second accepting step of accepting, from the photographer during the continuous photographing, a switching instruction to switch a photographing speed of the continuous photographing;
a setting step of setting a first photographing speed to be used in the continuous photographing, and a second photographing speed to be used as the photographing speed of the continuous photographing in accordance with the switching instruction; and
a control step of performing control of the continuous photographing, and
wherein in accordance with the start instruction of the continuous photographing, in the control step, the image sensor executes the image pickup processing at a photographing speed equal to or faster than the second photographing speed, and a development processing with respect to image signals that have been obtained by the image pickup processing and have been retained, and a processing of recording the processed image signals that have been obtained by the development processing on a recording medium are executed based on the first photographing speed, and
in accordance with the switching instruction, in the control step, the image sensor executes the image pickup processing at the second photographing speed, a development processing with respect to image signals that have been retained during a predetermined period going back from a time point when the switching instruction has been accepted and that have not yet been subjected to the development processing, and a processing of recording the processed image signals that have been obtained by the development processing on the recording medium are executed, and a development processing with respect to image signals that have been retained after the switching instruction, and a processing of recording the processed image signals that have been obtained by the development processing on the recording medium are executed based on the second photographing speed.

16. A control method for an image pickup apparatus that comprises an image sensor and a retaining unit configured to temporarily retain image signals that have been obtained through an image pickup processing performed by the image sensor, the control method comprising:
a first accepting step of accepting, from a photographer, a start instruction to start continuous photographing;
a second accepting step of accepting, from the photographer during the continuous photographing, a switching instruction to switch a photographing speed of the continuous photographing;
a first setting step of setting a first photographing speed to be used in the continuous photographing, and a second photographing speed to be used as the photographing speed of the continuous photographing in accordance with the switching instruction;
a second setting step of setting a faster photographing speed out of the first photographing speed and the second photographing speed to a photographing speed at a start of the continuous photographing; and
a control step of performing control of the continuous photographing, and
wherein in accordance with the start instruction of the continuous photographing, in the control step, the image sensor executes the image pickup processing at a photographing speed equal to or faster than the photographing speed that has been set in the second setting step, and a development processing with respect to image signals that have been obtained by the image pickup processing and have been retained, and a processing of recording the processed image signals that have been obtained by the development processing on a recording medium are executed based on the first photographing speed, and
in accordance with the switching instruction, in the control step, the image sensor executes the image pickup processing at the second photographing speed, a development processing with respect to image signals that have been retained during a predetermined period going back from a time point when the switching instruction has been accepted and that have not yet been subjected to the development processing, and a processing of recording the processed image signals that have been obtained by the development processing on the recording medium are executed, and a development processing with respect to image signals that have been retained after the switching instruction, and a processing of recording the processed image signals that have been obtained by the development processing on the recording medium are executed based on the second photographing speed.

17. A non-transitory computer-readable storage medium storing a program for causing a computer to execute a control method for an image pickup apparatus that comprises an image sensor and a retaining unit configured to temporarily retain image signals that have been obtained through an image pickup processing performed by the image sensor, the control method comprising:
a first accepting step of accepting, from a photographer, a start instruction to start continuous photographing;
a second accepting step of accepting, from the photographer during the continuous photographing, a switching instruction to switch a photographing speed of the continuous photographing;
a setting step of setting a first photographing speed to be used in the continuous photographing, and a second photographing speed to be used as the photographing speed of the continuous photographing in accordance with the switching instruction; and
a control step of performing control of the continuous photographing, and
wherein in accordance with the start instruction of the continuous photographing, in the control step, the image sensor executes the image pickup processing at a photographing speed equal to or faster than the second photographing speed, and a development processing with respect to image signals that have been obtained by the image pickup processing and have been retained, and a processing of recording the processed image signals that have been obtained by the development processing on a recording medium are executed based on the first photographing speed, and
in accordance with the switching instruction, in the control step, the image sensor executes the image pickup processing at the second photographing speed, a development processing with respect to image signals that have been retained during a predetermined period going back from a time point when the switching instruction has been accepted and that have not yet been subjected to the development processing, and a processing of recording the processed image signals that have been obtained by the development processing on the recording medium are executed, and a development processing with respect to image signals that have been retained after the switching instruction, and a processing of recording the processed image signals that have been obtained by the development processing on the recording medium are executed based on the second photographing speed.

18. A non-transitory computer-readable storage medium storing a program for causing a computer to execute a control method for an image pickup apparatus that comprises an image sensor and a retaining unit configured to temporarily retain image signals that have been obtained through an image pickup processing performed by the image sensor, the control method comprising:
a first accepting step of accepting, from a photographer, a start instruction to start continuous photographing;
a second accepting step of accepting, from the photographer during the continuous photographing, a switching instruction to switch a photographing speed of the continuous photographing;
a first setting step of setting a first photographing speed to be used in the continuous photographing, and a second photographing speed to be used as the photographing speed of the continuous photographing in accordance with the switching instruction;
a second setting step of setting a faster photographing speed out of the first photographing speed and the second photographing speed to a photographing speed at a start of the continuous photographing; and
a control step of performing control of the continuous photographing, and
wherein in accordance with the start instruction of the continuous photographing, in the control step, the image sensor executes the image pickup processing at a photographing speed equal to or faster than the photographing speed that has been set in the second setting step, and a development processing with respect to image signals that have been obtained by the image pickup processing and have been retained, and a processing of recording the processed image signals that have been obtained by the development processing on a recording medium are executed based on the first photographing speed, and
in accordance with the switching instruction, in the control step, the image sensor executes the image pickup processing at the second photographing speed, a development processing with respect to image signals that have been retained during a predetermined period going back from a time point when the switching instruction has been accepted and that have not yet been subjected to the development processing, and a processing of recording the processed image signals that have been obtained by the development processing on the recording medium are executed, and a development processing with respect to image signals that have been retained after the switching instruction, and a processing of recording the processed image signals that have been obtained by the development processing on the recording medium are executed based on the second photographing speed.
